(19) United States
(12) Patent Application Publication
(10) Pub. No.: US 2021/0114250 A1
(43) Pub. Date: Apr. 22, 2021

(54) METHOD AND APPARATUS FOR REDUCING LOSS DUE TO CHIPOUT

(71) Applicant: Jeff Chandler, Medina, MN (US)

(72) Inventor: Jeff Chandler, Medina, MN (US)

(21) Appl. No.: 17/074,318

(22) Filed: Oct. 19, 2020

Related U.S. Application Data
(60) Provisional application No. 62/923,427, filed on Oct. 18, 2019.

(51) Int. Cl. B27C 5/06; B27C 9/00; B27F 1/06

(52) U.S. Cl. CPC B27C 5/06; B27F 1/06; B27C 9/00

(57) ABSTRACT

A jump cutting device for use in forming a wooden work piece includes a cutting tool, and a mechanism for moving the cutting tool at an angle between the direction of a crosscut and a direction perpendicular to the cross cut direction. The deepest portion of the cut into the workpiece occurs on a tangent point of the tool. The profile of the cutting tool is a blend of the lineal and cross grain profiles.

### CROSS-REFERENCE TO RELATED APPLICATION

This application claims the benefit of U.S. Provisional Application No. 62/923,427 filed on Oct. 18, 2019, the entire contents of which is hereby incorporated by reference herein.

### TECHNICAL FIELD

Various embodiments described herein relate to a method and apparatus for reducing loss due to chip out on wooden workpieces.

### BACKGROUND

Many industries use wood as a raw material. These industries form and shape the wood into desirable and functional shapes needed for the final product which they assemble as part of production. Whenever cutting or shaping wood, there is the possibility of chipout. Chipout is when wood fibers, splinters or even large chunks of wood break away when wood is being cut or shaped. Chipout occurs most frequently when a rotary tool makes cross grain cuts on a wooden workpiece. Some products, such as wooden pallets, do not concern themselves with chipout. A pallet is for carrying loads of product. It does not have to look pretty. In fact, in many instances a pallet takes a beating rather than the product or products which it protects. Products or a product can be strapped to a pallet. The pallet can be lifted with a forklift and moved to various locations during transportation of the product within a plant and from the plant to market. The pallet is functional. Basically, a pallet is sacrificed. In addition to taking a beating, the pallet also allows many smaller products to be bundled together in one package for easy transport. Pallets can be loaded into semi tractor trailers for transport. The pallet is also used to store product at its final destination. The pallet is a rough product. If chipouts occur when cutting individual boards to make a pallet, it is of little concern unless the chipout is huge or presents a sharp or dangerous edge. Since a pallet does not have to look pretty, most chipouts are of little concern.

Other wood products feature the wood and must be aesthetically pleasing to the eye. Among such wood products are house trim, windows, cabinets, and the like. If a chipout, can be seen in the final product as assembled, the part is generally rejected. Chipout is a big problem. In some industries ten percent of the parts are rejected because of chipout. Many times the chipout occurs during one of the last operations on a part so when chipout occurs this costs a fair amount of money as the labor in the part must also be accounted for. The end result is that chipouts are a costly problem for manufacturer's of products using wood.

One method of reducing chip out it a method call jump cutting with counter-rotating cutters. Cuts along the grain of the wood (also known as lineal cuts) generally do not have as many problems with chipout when compared to cross-grain cuts. Cuts that cross the gain generally have more problems with chipout. Chipout occurs most frequently at the end of a cross cut, where a cutting tool is cutting near the end of a cut. In most instances at the end of a cross cut, the rotation tool is about to exit the cross cut. When the blade or cutting tool exits the wood, the last bit of wood held at the grain tends to release and go in the direction of the cutting tool as it exits. The jump cut method reduces chipout in these situations. A jump cut tool cuts out the backside of the main cut and is removed from the workpiece. The main cutting tool then cross cuts the piece and the visible chipouts are lessened because the material near the end of the cut has already been removed by the jump cut.

Use of a jump cut tool is not without its problems. The jump cut tool can still cause chipout problems. An invisible chipout can still cause problems in that two pieces meant to fit with one another, for example rail (horizontal piece) and a stile (vertical piece) for a window, may not fit or seal properly when there is a chipout that cannot be seen. The result is a rejection of the part. By the time a part or parts are rejected based on a chipout, many times the part has been worked on and the piece is worth well over the cost of the raw material.

A jump cut machine also may present other problems. The jump cutter must be precisely aligned with the main cutting tool so that a ledge is not produced when a fixed cut tool completes the cross cut.

There will always be a need for an apparatus and method that can be used to further reduce the problem of chipout so that the number of rejected parts is lessened. There is also a need for a machine that can reduce chipout in parts while operating at manufacturing speed. In many instances chipout problems are reduced by making multiple cuts which adds time to manufacturing.

### SUMMARY OF THE INVENTION

A jump cutting device for use in forming a wooden work piece includes a cutting tool, and a mechanism for moving the cutting tool from a workpiece before it cuts at a full depth. The jump cutting tool can be thought of as being removed before the possible full depth of a cut on the work piece. In one embodiment, the jump cutting tool is capable of cutting a corner between the molding cut on a wooden workpiece and the cross cut on a wooden workpiece. The jump cutting tool is removed from the workpiece prior to reaching full depth. The cut ends on a tangent point which is at less than a full depth. The tangent point is selected so that a sufficient amount of material is removed so that chipout does not occur when the stationary cutter completes the cut. The profile of the jump cutter varies with the tangent point of the deepest point of the jump cutter engagement into the workpiece. The profile of the tool must be such that it does not alter the lineal profile of the workpiece when it engages it at a tangent of the tool. Therefore, a tangential tool profile is not like either the with the grain, or lineal profile, or the cross grain, or end cut profile. It is a blend of the two, which varies dependent on the angle of tangency.* In some embodiments, the angle is in a range of 20-65 degrees from the crosscut direction. In other embodiments, the angle is in a range of 35-55 degrees from the crosscut direction. In still other embodiments, the angle is in a range of 40-50 degrees from the crosscut direction. In yet another example embodiment, the angle is 45 degrees from the crosscut direction. The jump cutting tool is moved into position to make the backside of a cross cut and “jumps” out of the way before completing the cut. The wooden work piece is moved to a fixed cutting tool that makes the front portion of the cut. The level of the jump tool and the fixed cutting tool have to be substantially the same so the finished cross cut is smooth. Thus, the cut made by the jump cutting tool substantially matches the cross cut made by the fixed cutting device so as to produce a substantially smooth final molding cut. Additionally, the jump cutting tool also makes cuts that substantially match the lineal, cut with grain. The jump cutting tool makes a portion of the cross grain cut and the lineal cut along the grain. In one embodiment, the jump cutting tool is a single cutting tool. The single cutting tool includes cutters or blades to match the cross grain cut and the along the grain or lineal cut. In one embodiment, the jump cutting device forms a corner between the cross grain cut and the lineal or along the grain cut of a wooden workpiece. The jump cutting tool of has a profile that cuts portions of the molding, or lineal cut and portions of the cross gain cut of a wooden workpiece.

A method of forming a wooden workpiece includes cross cutting a wooden workpiece in a first direction with a first cutting tool, that can cut a portion of the cross grain cut before the first cutting tool exits the workpiece, and removing the first cutting tool before the workpiece gets to the second cutting tool. The first cutting tool is moved from an engaged position with the workpiece to a non-interfering position before engaging the wooden workpiece at and near an exit end of a crosscut with a second cutting tool.

Generally, the deepest portion of the cut into the workpiece of cut made by the tangential cutting tool occurs on a tangent point of the tangential cutting tool. Therefore, in one embodiment, the first cutting tool maximum depth of cut into a workpiece is at an angle in the range of 20-65 degrees with respect a line parallel to the direction of the cross grain cut. In another embodiment, the first cutting tool maximum depth of cut into a workpiece is at an angle in the range of 35-55 degrees with respect a line parallel to the direction of the cross grain cut. In still another embodiment, the first cutting tool maximum depth of cut into a workpiece is at an angle in the range of 40-50 degrees with respect a line parallel to the direction of the cross grain cut. In yet a further embodiment, the first cutting maximum depth of cut into a workpiece is workpiece at an angle of about 45 degrees with respect a line parallel to the direction of the cross grain cut. In another embodiment, the first cutting tool maximum depth of cut into a workpiece is along a tangential line to a circle formed from a radius of curvature at the point of exit from the workpiece. The second cutting tool is at a level to match the cross grain cut.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures.

FIG. 1A shows a generalized view of a machine for shaping wood to be used in windows, cabinets, or the like, at a time t1, according to an example embodiment.

FIG. 1B show a generalized view of a machine for shaping wooden workpieces to be used as parts for windows, cabinets, or the like, at a time t2, according to an example embodiment.

FIG. 1C shows a generalized view of a machine 100 for shaping wooden workpieces to be used as parts for windows, cabinets, or the like, at a time t3, according to an example embodiment.

FIG. 2A is a schematic view of a fixed cutting tool about to make a profile cut or cross grain cut, according to the prior art.

FIG. 2B is a schematic view of a fixed cutting tool making a profile cut or cross grain cut, according to the prior art.

FIG. 2C is a schematic view of a fixed cutting tool about to finish a profile cut or cross grain cut, according to the prior art.

FIG. 3A is a schematic view of a jump cutting tool making a profile cut or cross cut on a wooden work piece, according to the prior art.

FIG. 3B is a schematic view of a jump cutting tool being removed before completing the profile cut or cross cut on a wooden work piece, according to the prior art.

FIG. 3C is a schematic view of a fixed cutting tool making a profile cut or cross cut on a wooden work piece to complete the profile cut after the jump tool cut, according to the prior art.

FIG. 4 is a schematic view of a counter-rotating jump cutting tool which moves substantially perpendicular to the cross cut when exiting a cross cut on a wooden work piece, and according to the prior art.

FIG. 5A is an example of a cope cut for a window sash, according an example embodiment.

FIG. 5B is a cope cut on a cabinet door component, according an example embodiment.

FIG. 5C is another example of a cope cut on a six panel door component, according an example embodiment.

FIG. 5D is a component with tongue and could be floor boards or wall siding, according an example embodiment.

FIG. 6 is a perspective view of a jump cutting tool and the resulting cuts in the lineal direction and the cross cut, according an example embodiment.

FIG. 7 is a perspective view of a portion of a workpiece that is formed with the jump cutting tool of FIG. 6, according an example embodiment.

FIG. 8 is a flow diagram of a method of forming and using a tangential jump cutting tool that jumps out at non perpendicular angle with respect to the cross cut to reduce the amount of wood exposed to chipout, according an example embodiment.

FIG. 9 is a view of a kit that includes jump cutting tool and a set of instructions for using the jump cutting tool, according to an example embodiment.

FIG. 10A illustrates a jump cope cutter as it cuts a cross member to a first position, according to an example embodiment.

FIG. 10B, illustrates a jump cope cutter as it cuts a cross member to a second position, according to an example embodiment.

FIG. 10C illustrates a jump cope cutter as it cuts a cross member to a third position, according to an example embodiment.

### DETAILED DESCRIPTION

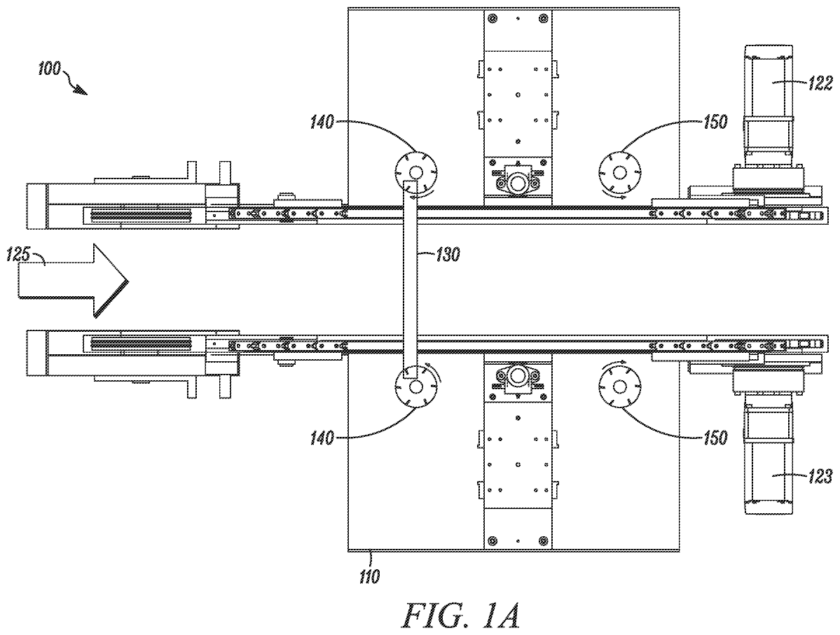

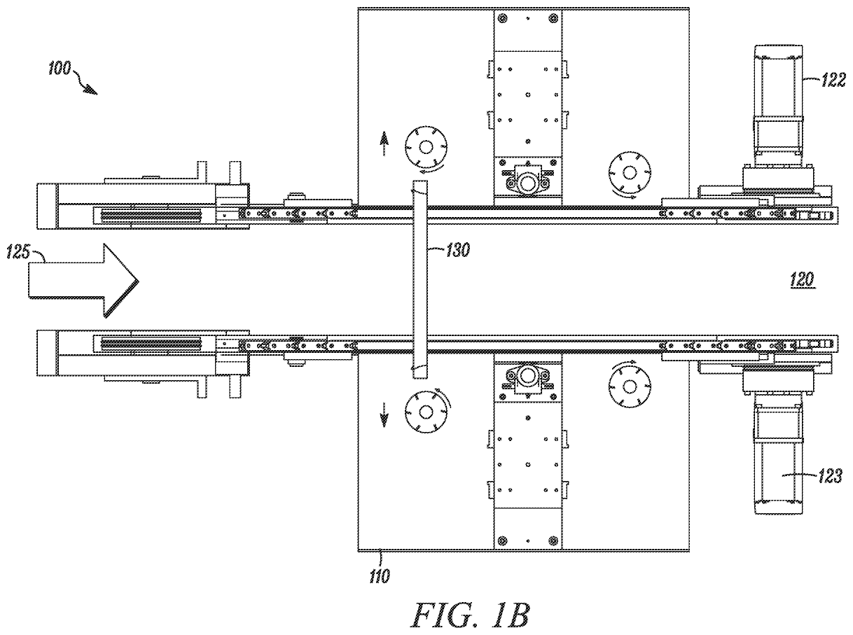

FIGS. 1A, 1B, and 1C show a generalized view of a machine 100 for shaping wooden workpieces 100 to be used as parts for windows, cabinets, or the like, at times t1, t2 and t3, respectively, according to an example embodiment. The machine will be described initially with respect to FIG. 1A. Later FIGS. 1A, 1B, and 1C will be used to describe the time sequence for making various cuts to complete a cross cut on a workpiece. The machine 100 includes a table 110, and a conveyer 120 for moving a wooden workpiece 130. The conveyer 120 is driven by at least one feed chain drive motor 122. As shown in FIG. 1, there is a first feed chain drive motor 122, and a second feed chain drive motor 123. The workpiece 130 is attached to the conveyor 120 and moved in a direction indicated by arrow 125. The machine 100 also includes at least one jump cope tool 140 and at least one fixed cut tool 150. The machine 100 shown in FIG. 1 is a double end machine so can cut both ends of a workpiece 130 substantially simultaneously. As a result, the machine 100 shown in FIG. 1 includes two jump cope cutters 140 and stationary or fixed cope cutters 150. It should be noted that the jump cope cutters 140 rotate in a first direction while the stationary/fixed cope cutter rotate in an opposite direction. Cross grain cuts are most susceptible to chipout, especially when the width of the workpiece is narrow. In these instances, the jump cut made with the jump cope cutter is controlled so that a sufficient amount of wooden material is left behind for the stationary cope cutter to work on without causing chip out. If the workpiece is relatively wide, the jump cope cutter 140 can cut to its maximum depth. If not, the jump cope cutter 140 is cutting a narrow width workpiece 130 the jump cope cutter 140 is removed before reaching maximum of full depth. This leaves more material in the wooden workpiece 130 for the stationary or fixed cope cutter 150 to cut. Generally, chances for chipout are lessened when there is more material left to cut.

The jump cope cutter 140 that makes a cut along the portion of a work piece at and near the portion where the fixed cope cutter 150 will complete the cross cut on the work piece 130. The first cutter, or jump cope cutter 140, cuts the entrance area or leading edge of the workpiece first and then removed (i.e. “jumps” out of the way) before cutting through the trailing edge of the workpiece. The first cutter or jump cope cutter is removed before the fixed cope cutter initializes a cut. In either event, the first or jump cutter moves to a position where it is disengaged from the work piece and where it will not interfere with the fixed cutter. It should be noted that the first and second tools must be capable of making the same cuts and the levels of the first and second tools must be set to produce a smooth cut in the work piece.

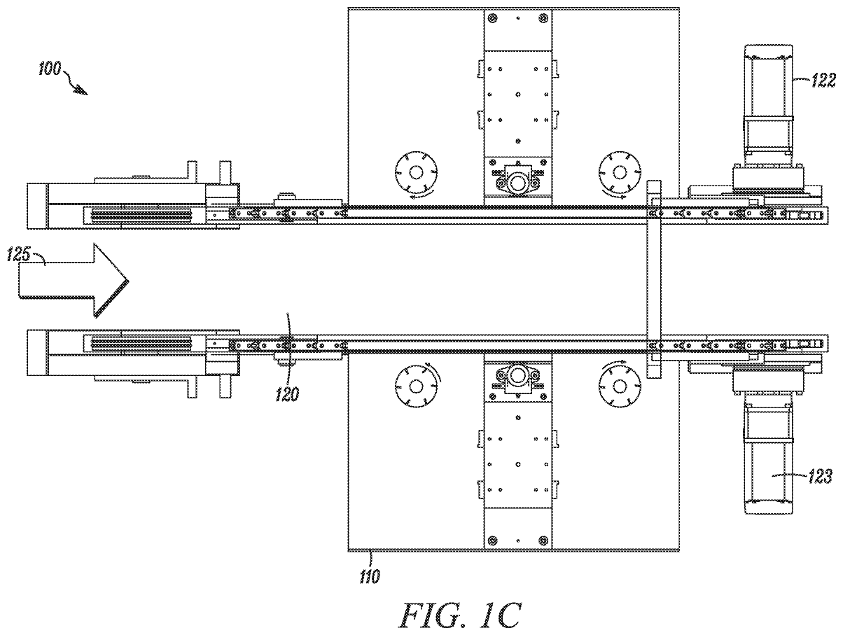

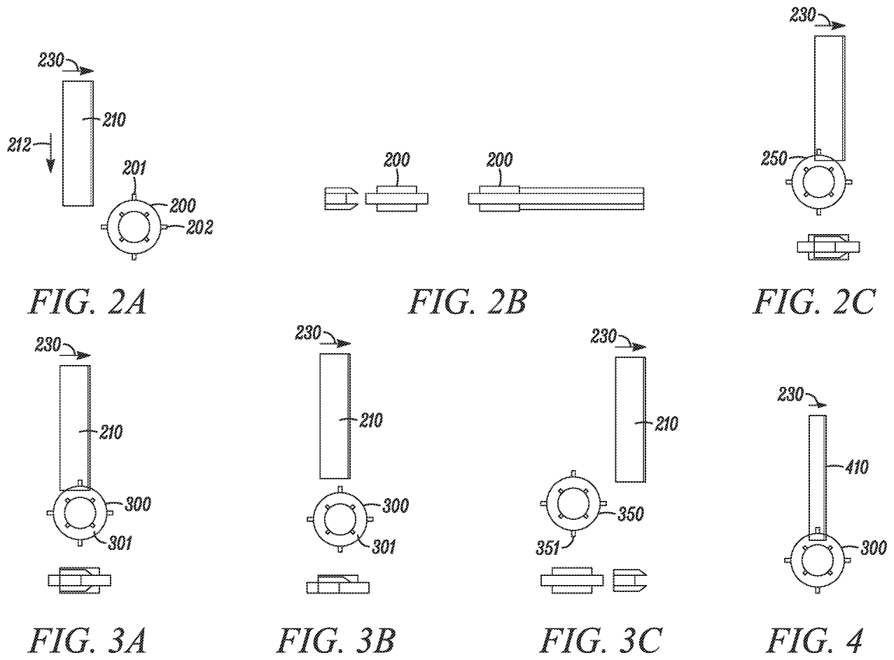

FIG. 2A is a schematic view of a fixed cutting tool 200 about to make a profile cut or cross grain cut, according to the prior art. FIG. 2B is a schematic view of a fixed cutting tool 200 making a profile cut or cross grain cut, according to the prior art. FIG. 2C is a schematic view of a fixed cutting tool 200 about to finish a profile cut or cross grain cut, according to the prior art. In FIGS. 2A-2C, there is no jump cut tool used when making the cross grain cut on a wooden work piece 210. Now referring to FIGS. 2A, 2B, and 2C, the prior art cutting tool will be discussed. The cutting tool cuts with at least one cutting tooth 212. In most embodiments, the fixed cutting tool includes a plurality of teeth 212. The cutting tool can also have more than one level of cutters, although the one shown in FIGS. 2A, 2B, 2C shows a single cutter.

The wooden work piece 210 has wood grain essentially along a line 212. The wood travels in a direction substantially perpendicular to the line 212 and substantially perpendicular to the direction of the grain of the wood. It should be noted that grains in wooden workpieces do not form nice straight lines but the line 212 generalizes the direction of the grain. Line 230 depicts the direction of travel of the work piece 210. The line of travel of the workpiece 230 is substantially perpendicular to the direction of the wood grain 212. Along the grain, or at the grain boundaries, wood tends to be weakly held together or at least more weakly held together than the wood between the grain lines. Toward the end of the cut, as shown in FIG. 2C, at an exit point near point 250. When the spinning cutter exits the work piece it may not do so cleanly. Rather than leave the wood cleanly, many times the spinning cutter 200 produces a force that breaks at least a portion of the wood along the grain near the exit point 250. The result, about 10% of the time, is a chip or an unintended extra portion of wood being removed beyond the intended cut. The resulting chip or divot may be of little import in some instances. In other instances where the looks or aesthetics of the product count, the chip out will result in a rejection of the work piece. By the time final cuts are being made, it is near the end of the process for the part and so the part will have a certain amount of labor cost associated therewith in addition to the cost of the raw work piece.

FIG. 3A is a schematic view of a jump cutting tool 300 making a profile cut or cross cut on a wooden work piece, according to the prior art. FIG. 3B is a schematic view of a jump cutting tool 300 being removed before completing the profile cut or cross cut on a wooden work piece, according to the prior art. Now referring to both FIGS. 3A and 3B, the jump cutting tool 300 as used in the prior art will be further detailed. The jump cutter tool 300 was employed to lessen the number of chip outs on wooden work piece 210. The work piece moves in the direction 230 as it is being processed. The whole idea behind using a jump cutter tool 300 is to remove some of the material on the work piece 210 initially so as to lessen the possibility of chip outs. The jump cutter 300 rotates in a counter-clockwise direction. The tool makes a portion of the cut and is then removed before it finishes the cut. As shown in FIG. 3B, the workpiece moves from right to left as depicted by arrow 230 and the jump cutter 300 is moved to a distance where at least the deepest portion of the profile is cut. Removal of this portion prevents tear out on the right hand side of the workpiece 210 where the clockwise rotating fixed cutter 320 would normally contact wood at the grain boundary with the potential of tearing it out and causing a chip out defect.

FIG. 3C is a schematic view of a fixed cutting tool 350 after making a profile cut or cross grain cut on a wooden work piece 210, according to the prior art. The fixed cutter 350 rotates in the opposite direction as the jump tool. As shown by arrow 352, the fixed cutter rotates in a clockwise direction. When the fixed cutter completes the cross grain cut, there is nothing to tear out as the fixed cutter 350 enters the right hand side of the workpiece 210, The fixed cutter 350, rotating in the clockwise direction 352, is moved so that it removes material and completes the cut. The rotation in the clockwise direction places a force on the wood at the left-hand side of the workpiece toward the workpiece. In other words, the clockwise direction places the wood produces a compressive force at the left-hand side when exiting the workpiece which is less prone to tear out. Put another way, the right-hand side of the workpiece 210 does not chip-out because it was previously cut out by the jump cutting tool 300. The left-hand side of the workpiece 210 does not chip out because the stationary or fixed cutter 350 rotates into the right-hand side of the part or workpiece 210. In the prior art method, the jump cutter is moved into the work piece until the jump cutter is cutting at full depth.

The prior art method still has problems with tear out or chip out. This is especially true when the wooden member has a small width. When the jump cutter 300 jumps away or is removed from the workpiece or is moved away from the workpiece, the spinning blades may be positioned near a grain boundary. In some instances, the grain boundary gives way producing an unwanted chip out along a back edge or midway through the cross grain cut. In some instances, the unwanted removal of wood midway through the cross grain cut can not be seen but causes a defect when joining the workpiece to another workpiece to form the final product.

FIG. 4 is a schematic view of a counter-rotating jump cutting tool which is attempting a partial cross grain cut on a narrow wooden work piece 410, and according to the prior art. The counter rotating jump cut technique does not work well on a narrow workpiece 410. When the workpiece is narrow, such as the one shown in FIG. 4, the radius of the tool 300 exits the part very near the deepest part of the profile. This allows only a very small amount of chip-out before causing a defect. In other words, when the workpiece is narrow, there is very little material left on the left hand side of the part when the jump or removal of the jump tool occurs. In some instances, such as that shown in FIG. 4, portions of the left-hand side have been removed. The jump cut tool 300 can cause chip out just like a fixed cutting tool. There is very little material to chip out and there is a chance that a chip out can be produced that is larger than the cut resulting in a defective part. Basically, on a workpiece with a small width, using a jump tool to cut to full depth also has a relatively high probability of producing a chipout type defect because not much material is left behind in this scenario.

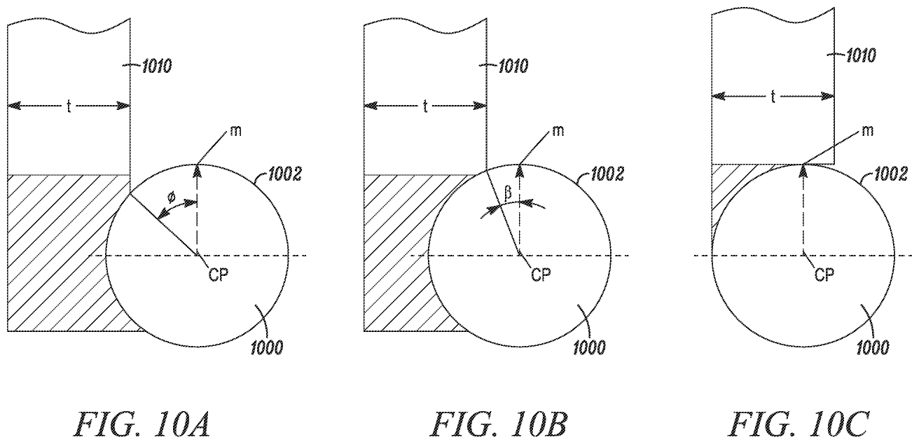

The FIGS. 10A-10C illustrate the innovation at the heart of the invention. This paragraph will be a brief overview of the innovation. The innovation is to remove the jump cutting tool before it cuts at full depth so that more material is left after the jump cut. The added material makes it less likely that there will be a chipout caused by the jump cope cutter or by a fixed cope cutter. The overall concept is to make a partial cut which is removed before the jump cope cutter reaches full depth so that enough material is removed on the backside of the crosscut to prevent chipout by the fixed cope cutter. The amount of material left also has to be substantial enough so that the jump cope cutter does not cause a chipout type defect. When making a partial cut with a jump cope cutter, the blade arrangement on the cutter changes geometrically so that when removed, the resulting cut will match the cross cut of the fixed cope cutting tool.

FIGS. 10A, 10B, and 10C illustrate a jump cope cutter 1000 as it cuts a cross member 1020, according to an example embodiment. The FIGS. 10A-10C illustrate the concept at the heart of the invention. Namely FIG. 10A illustrates a jump cope cutter 1000 as it cuts a cross member 1010 to a first position, according to an example embodiment. FIG. 10B, illustrates a jump cope cutter 1000 as it cuts a cross member 1010 to a second position, according to an example embodiment. FIG. 10C illustrates a jump cope cutter 1000 as it cuts a cross member 1010 to a third position, according to an example embodiment. The circle in each of FIGS. 10A, 10B and 10C represent the outer radius 1002 of the cutting blades associated with the jump cope cutter 1000. The outer radius 1002 can also be thought of as the outer edge of the blade of the jump cope cutter 1000. FIG. 10A shows the jump cope cutter 1000 cutting into the workpiece or crossmember 1010 to a point where the blades are cutting along a tangent which is perpendicular to the angle alpha, α shown in FIG. 10A. In some embodiments of the invention, the jump cope cutter 1000 is removed from the workpiece or crossmember at this point in time. The jump cope cutter 1000 has not reached maximum depth which is denoted by point m which is directly above the center point of the circle of the jump cope cutter 1000. It can be seen that plenty of material 1030 is left to be cut in the crossmember 1010. In some embodiments, the jump cope cutter 1000 is removed form making a deeper cut at this point. It should be understood that there are many ways to achieve the removal of the jump cope cutter 1000 which include moving the crossmember 1010, moving the jump cope cutter 1000 by rotating it away or moving the cutter linearly away, or by lifting the jump cope cutter 1010. The remaining material 1030 is cut by a fixed cutter (not shown in FIGS. 10A-10C but shown as fixed cope cutter 150 in FIGS. 1A-1C).

FIG. 10B shows the jump cope cutter 1000 cutting into the workpiece or crossmember 1010 to a point where the blades are cutting along a tangent which is perpendicular to the angle beta, β, shown in FIG. 10B. As shown, the jump cope cutter 1000 is cutting more deeply into the workpiece 1010 and removing more material when compared to FIG. 10A. The angle β (shown in FIG. 10B) is less than the angle α (shown in FIG. 10A). The jump cope cutter 1000 can be removed at this point leaving the material 1031 to be removed by a fixed cutter. There is less material 1031 than the amount left in FIG. 10A denoted by 1030.

FIG. 10C shows the jump cope cutter 1000 cutting the cross member to maximum depth which is above the center point of the jump cope cutter 1000. This leaves less material 1032 when compared to when the jump cope cutter 1000 is removed at angle α (FIG. 10A) or at angle β (FIG. 10B). Generally, the smaller the width t of the material the larger the angle where the jump cope cutter 1000 is removed. At larger angles, more material is left. With more material left, the fixed cope cutter is generally less likely to have a chipout type of defect in the cut. However, this is a matter of trial and error. The angle, such as angle α or angle β is changed or adjusted until the jump cope cutter 1000 and the fixed cope cutter 150 can make the cut with the least amount of chipout on either cut. In essence the jump cope tool 1000 can be removed

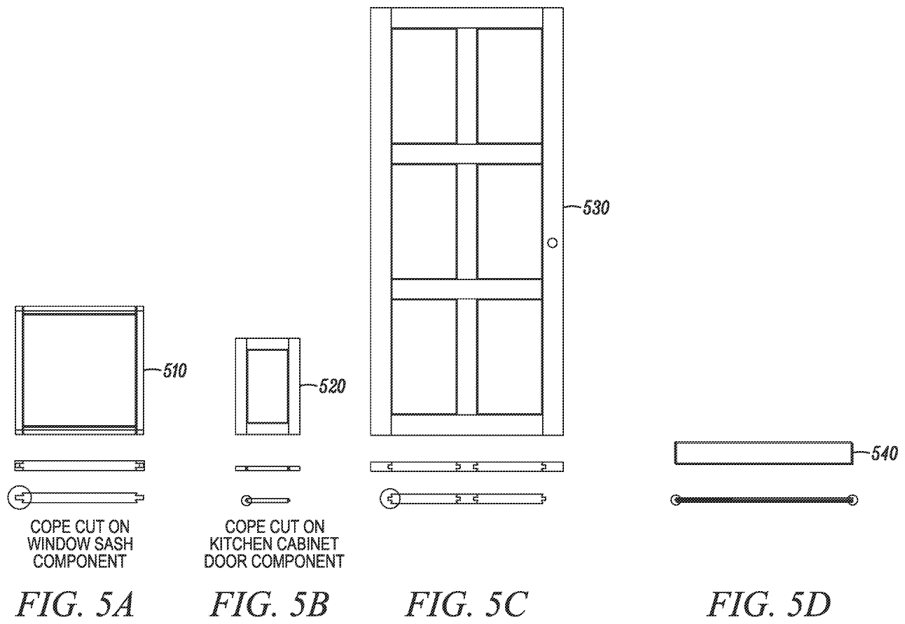

FIGS. 5A-5D are examples of cope cuts for various wooden products. FIG. 5A is an example of a cope cut for a window sash 510 FIG. 5B is a cope cut on a cabinet door component 520. FIG. 5C is another example of a cope cut on a six-panel door component 530. FIG. 5D is a component with tongue and could be floorboards or wall siding 540. Basically, a cope cut is made on the ends of wooden components so that one end of a component fits into another end of an adjacent wooden component. This, the cope cut of the floorboards or siding can be thought of as “tongue and groove” type cuts. On a cabinet or window, the cope cuts form cuts which join at the corners of the frame. When the jump tool is removed from a cut prior to the jump cope cutting tool reaching maximum depth, it is notable that the jump cope cut tool will form a portion of the cross cut and a portion of the lineal cope cut on a wooden workpiece. The portion of the cut above the maximum depth of the crosscut will be forming a portion of the lineal cut and will have to produce a portion of the lineal cut that matches up with the lineal cut. The tangential jump cope cutters, that are removed from the crosscut before reaching full depth, will have a different profile than the cutters that reach full depth. When forming a wooden workpiece which will form a corner with another wooden workpiece both a cross grain cut and a lineal cut along the grain is made. The cope cutters that are removed before making a full depth cut (also known as a tangential cope cutter) have to cut a portion of the cross grain cut. The blades of the cutters can not remove more material associated with the lineal cut.

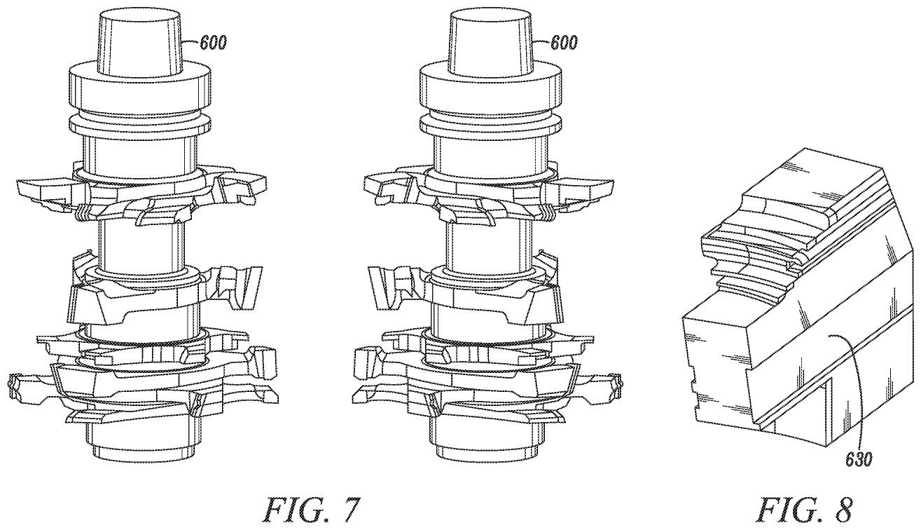

FIG. 6 is a perspective view of a jump cutting tool 600 and the resulting cuts in the lineal direction and the crosscut direction, according an example embodiment. FIG. 7 is a perspective view of a portion of a workpiece 630 that is formed with the jump cutting tool 600, according an example embodiment. Now referring to both FIGS. 6 and 7, an example embodiment of the invention will now be further detailed. The jump cutting tool 600 includes at least a first set of blades 610 and a second set of blades 720. The first set of blades 610, which includes blades 612, 614, and 616 which make portions of the cross cut on a work piece 630. The second set of blades 620 includes blades 622, 624, 626 for making a portion of the cross grain cut along the workpiece 630. Of course, the jump cutting tool can be rotated in either a clockwise or counterclockwise direction.

The cutting tool 600 can be thought of as moving tangentially with respect to the work piece 630. In one embodiment, the jump cutting tool is capable of cutting a corner between the molding cut on a wooden workpiece and the cross cut on a wooden workpiece. The jump cutting tool 600 moves into a cutting position and out of a cutting position before the full cutting tool depth is achieved. The angle between an upright or blade contacting the workpiece when cutting at full depth, and the angle at which the blade is cutting at when removed is referred to as the tangential cutting angle. In some embodiments, the angle is in a range of 20-65 degrees from the crosscut direction. In other embodiments, the angle is in a range of 35-55 degrees from the crosscut direction. In still other embodiments, the angle is in a range of 40-50 degrees from the crosscut direction. In yet another example embodiment, the angle is 45 degrees from the crosscut direction. The jump cutting tool 600 is moved into position to make the backside of a crosscut and “jumps” out of the way or is removed before completing getting to the maximum depth of the cut. It should be noted that the angle actually will vary depending on the width of the workpiece, the properties of the wood and other factors. Generally, the tangential angle will be between 0 and 90 degrees. The tangential angle, in some embodiments, will be determined by trial and error. Initially, an angle will be selected and tried. The angle will be varied until an optimum angle is found where the wooden work piece 630 has enough material removed from the backside of the cut so that the amount of chipout from a full depth cut with a fixed cutting tool is within an acceptable range. The amount left will also be selected so that the cutting tool does not cut deeper than a portion of the lineal cut. The cuts will also be selected so that the two cuts take a minimal amount of time. This helps to maintain throughput in the manufacturing process. that cuts the front portion of the cut after the jump cutter 600 is removed. The level of the jump tool 600 and the fixed cutting tool (not shown in FIGS. 6 and 7) have to be substantially the same so the finished crosscut is smooth. Thus, the cut made by the jump cutting tool 600 substantially matches the crosscut made by the fixed cutting device so as to produce a substantially smooth final molding cut. Additionally, the jump cutting tool 600 also makes cuts that substantially match the lineal, cut with grain. The jump cutting tool makes a portion of the cross grain cut and the lineal cut along the grain. In one embodiment, the jump cutting tool 600 is a single cutting tool. The single cutting tool includes cutters or blades to match the cross grain cut and the along the grain or lineal cut. The jump cutting tool of has a profile that cuts portions of the cross gain cut of a wooden workpiece.

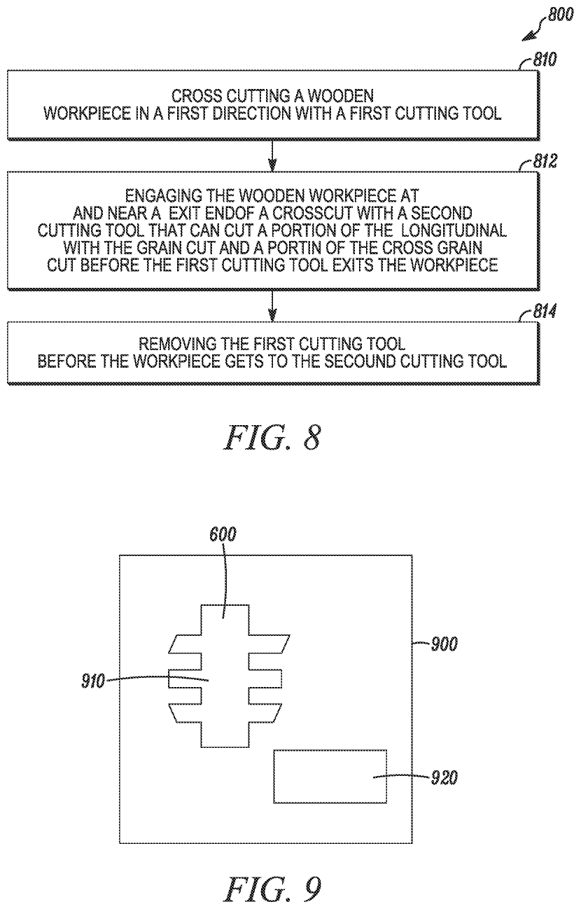

FIG. 8 is a flow diagram of a method 800 of forming and using a tangential jump cutting tool that removed at non perpendicular angle with respect to the cross cut to reduce the amount of wood exposed to chipout, according an example embodiment. The jump cutting tool is removed before it makes a full depth cross grain cut so as to leave more wood remaining so that a fixed cutting tool does not produce a chipout defect. The method 800 of forming a wooden workpiece includes cross cutting a wooden workpiece in a first direction with a first cutting tool 810, engaging the wooden workpiece at and near an entrance end of a crosscut with a first cutting tool that can cut a portion of the cross grain cut before the first cutting tool exits the workpiece 812, and removing the first cutting tool before the workpiece gets to the second cutting tool 814. The second cutting tool is moved from an engaged position with the workpiece to a non interfering position.

In one embodiment, the second cutting tool 600 exits or cuts until the radial to the tangent of the cutting tool is at an angle in the range of 20-65 degrees with respect a line parallel to the direction of the cross grain cut. In another embodiment, the second cutting tool exits the workpiece at an angle in the range of 35-55 degrees with respect a line parallel to the direction of the cross grain cut. In still another embodiment, the second cutting tool exits the workpiece at an angle in the range of 40-50 degrees with respect a line parallel to the direction of the cross grain cut. In yet a further embodiment, the second cutting tool exits the workpiece at an angle of about 45 degrees with respect a line parallel to the direction of the cross grain cut. In another embodiment, the second cutting tool is removed along a tangential line to a circle formed from a radius of curvature at the point of exit from the workpiece. The second cutting tool is at a level to match the cross grain cut. The workpiece is moved into the second cutting tool that is in a fixed position to complete the cross cut.

FIG. 9 is a view of a kit 900 that includes jump cutting tool 910 that has a set of blades for forming a portion of the cross cut and a portion of the lineal cut on a workpiece, such as workpiece 630. The workpiece is not included in the kit. The kit also includes a set of instructions 920 for using the jump cutting tool, according to an example embodiment. In another example embodiment of the kit 900 can include other cutting tools. The kit may include a plurality of substantially identical jump cutting tools 910. The jump cutting tools may be different and include different mounts for different machines. The jump cutting tools may be substantially identical so that as one of the jump tools wears, it can be replaced with other jump tools in the kit 900. The instructions include directions on using the jump cutting tool 900. The instruction set can include a listing of recommended exit angles or tangential angles for removing the jump cutting tool from the workpiece. It is contemplated that different widths of workpieces may have different recommended angles. The instructions may include a manual for use or may include a label that identifies the tool and which includes a link to a manual at a specified website.

The description set out herein illustrates the various embodiments of the invention and such description is not intended to be construed as limiting in any manner.

The foregoing description of the specific embodiments reveals the general nature of the invention sufficiently that others can, by applying current knowledge, readily modify and/or adapt for various applications without departing from the concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

1. A jump cutting device for use in forming a workpiece comprising:
a cutting tool; and
a mechanism for moving the cutting tool at an angle between the direction of a crosscut and a direction perpendicular to the cross cut direction.

2. The jump cutting tool of claim 1 wherein the cutting tool is capable of cutting a corner between the molding cut and the cross cut on a workpiece.

3. The jump cutting tool of claim 1 wherein the angle is in a range of 20-65 degrees from the crosscut direction.

4. The jump cutting tool of claim 1 wherein the angle is in a range of 35-55 degrees from the crosscut direction.

5. The jump cutting tool of claim 1 wherein the angle is in a range of 40-50 degrees from the crosscut direction.

6. The jump cutting tool of claim 1 wherein the angle is 45 degrees from the crosscut direction.

7. The jump cutting tool of claim 1 wherein the cuts made by the jump cutting device substantially match the lineal cut.

8. The jump cutting tool of claim 1 wherein the cuts made by the jump cutting device substantially match the lineal cut and the cross grain cut.

9. The jump cutting tool of claim 1 wherein the jump cutting device is a single cutting tool.

10. The jump cutting tool of claim 1 wherein the jump cutting device forms a corner between the cross cut and the molding cut of a wooden workpiece.

11. The jump cutting tool of claim 1 having a profile that cuts portions of the lineal cut and the cross cut of a wooden workpiece.

12. A method of forming a wooden workpiece comprising:
cross cutting a wooden workpiece in a first direction with a first cutting tool that can cut a portion of the cross grain cut before the first cutting tool exits the workpiece; and
removing the first cutting tool before the workpiece gets to the second cutting tool, the first cutting tool moved from an engaged position with the workpiece to a non interfering position before engaging the wooden workpiece at and near an exit end of a crosscut with a second cutting tool.

13. The method forming a workpiece of claim 12 wherein the first cutting tool maximum depth of cut into a workpiece is at an angle in the range of 20-65 degrees with respect a line parallel to the direction of the cross grain cut.

14. The method forming a workpiece of claim 12 wherein the first cutting tool maximum depth of cut into a workpiece is at an angle in the range of 35-55 degrees with respect a line parallel to the direction of the cross grain cut.

15. The method forming a workpiece of claim 12 wherein the first cutting tool maximum depth of cut into a workpiece is at an angle in the range of 40-50 degrees with respect a line parallel to the direction of the cross grain cut.

16. The method forming a workpiece of claim 12 wherein the first cutting tool maximum depth of cut into a workpiece is at an angle of about 45 degrees with respect a line parallel to the direction of the cross grain cut.

17. The method forming a workpiece of claim 11 wherein the first cutting tool is removed along a tangential line to a circle formed from a radius of curvature at the point of exit from the workpiece.

18. The method forming a workpiece of claim 11 wherein the first cutting tool is at a level to match the second cutting tool.
